(19) United States
(12) Patent Application Publication
(10) Pub. No.: US 2011/0212827 A1
(43) Pub. Date: Sep. 1, 2011

(54) FUSED CERAMIC PRODUCT

(75) Inventors: Emmanuel Pierre Marcel Nonnet, Sarrians (FR); Yves Marcel Leon Boussant Roux, Montfavet (FR); Charlotte Catteau, Boulbon (FR); Sophie Papin, Villeneuve La Garenne (FR); Gilles Querel, Compiegne (FR)

(73) Assignee: SAINT-GOBAIN CENTRE DE RECHERCHES ET D'ETUDES EURO, Courbevoie (FR)

(21) Appl. No.: 13/123,161

(22) PCT Filed: Oct. 16, 2009
(86) PCT No.: PCT/IB2009/054568

§ 371 Date: May 10, 2011

(30) Foreign Application Priority Data
Oct. 17, 2008 (FR) 08/57071

(51) Int. Cl. C04B 35/48; C09K 3/14; C03B 19/10; B02C 17/20; C03B 32/00

(52) U.S. Cl. 501/134; 65/33.9; 65/21.1; 51/308

(57) ABSTRACT

Process for manufacturing a product, including the following successive steps:
a) mixing raw materials to form a starting feedstock;
b) melting the starting feedstock so as to form a molten liquid;
c) solidifying the molten liquid so as to obtain a fused product comprising crystals linked by a glassy phase; and
d) crystallization heat treatment of the glassy phase of said fused product,
in which the composition of the starting feedstock is adapted in order to manufacture a product having the following chemical composition, as weight percentages based on the oxides, and for a total of 100%:
40%≦(ZrO₂+HfO₂)≦94%;
4%<CeO₂<31%;
0%≦Y₂O₃;
0%≦Al₂O₃;
2%≦SiO₂;
0%≦MgO;
0%≦TiO₂; and
other oxides≦1%.

### TECHNICAL FIELD

The present invention relates to a process for manufacturing ceramic products obtained by fusion, or “fused products”, and in particular fused particles usable in particular in apparatus and methods for microgrinding, microdispersion in wet medium and for surface treatment.

It also relates to products obtained or capable of having been obtained by this process.

### PRIOR ART

Apparatus and methods for microgrinding, microdispersion in wet medium and surface treatment are well known, and are developed in particular in industries such as:
the mining industry, which uses particles for fine grinding of dry preground materials by conventional methods, in particular for grinding calcium carbonate, titanium oxide, gypsum, kaolin, iron ore, ores of precious metals and, in general, all ores undergoing a chemical or physicochemical treatment;
the paint, ink, dye, magnetic lacquer, agrochemical compound industries, which use particles for the dispersion and homogenization of the various liquid and solid constituents;
the surface treatment industry, which relies on particles in particular for cleaning operations on metal moulds (for the fabrication of bottles, for example), debarring of parts, descaling, preparation of a support for a coating, shot peening, or peen forming.

The particles conventionally used for these markets are generally substantially spherical and between 0.005 and 4 mm in size. Depending on the intended markets, they may have one or more of the following properties:
chemical and dye inertia with regard to the products treated,
impact strength,
wear resistance,
low abrasiveness to equipment, particularly stirring members and tanks, or projection members, and
low open porosity for easy cleaning.

In the field of grinding, various types of particles are encountered, particularly sand with rounded grains, glass beads, particularly vitroceramized glass beads, or even metal beads.

Sand with rounded grains, like Ottawa sand for example, is a natural and inexpensive product, but unsuitable for modern grinders, which are pressurized and have high throughputs. This is because the sand has little strength, low density, is of variable quality and is abrasive for the equipment.

Glass beads, widely used, have better strength, lower abrasiveness and are available in a wider range of sizes.

Vitroceramized glass beads, like those described in JP-S61-168552 or JP-S59-174540, are stronger than ordinary glass beads.

Metal beads, particularly of steel, have also been known for many years for the abovementioned applications, but their use remains marginal because they often have insufficient chemical inertia to the products treated, in particular causing pollution of the mineral feeds and shading of paints, and an excessively high density demanding special grinders implying high power consumption in particular, substantial heating and high mechanical loading of the equipment.

Also known are ceramic particles, which have the advantage of better mechanical strength than the glass beads, high density, and excellent chemical inertia. Among these particles, a distinction can be made between:
sintered ceramic particles, obtained by cold shaping of a ceramic powder followed by consolidation by firing at high temperature, and
fused ceramic particles, generally obtained by melting a raw material feedstock, conversion of the molten liquid to droplets, and solidification thereof.

The large majority of fused ceramic particles used in the above-mentioned applications have a composition of the zirconia-silica (ZrO₂—SiO₂) type, in which the zirconia is crystallized in monoclinic form and/or partially stabilized (by appropriate additives), and in which the silica, and part of the optional additives, form a matrix binding the zirconia crystals.

These fused ceramic particles offer excellent properties for grinding, that is, good mechanical strength, high density, chemical inertia and low abrasiveness for the grinding equipment.

Fused ceramic particles based on zirconia and their use for grinding and dispersion are described for example in FR 2 320 276, EP 0 662 461 and FR 2 714 905. These documents thus describe the influence of SiO₂, Al₂O₃, MgO, CaO, Y₂O₃, CeO₂ and Na₂O on the main properties of the resulting particles, particularly on the properties of crushing strength and abrasion resistance.

Although the fused ceramic particles of the prior art are of good quality, the industry always needs products of even higher quality. This is because the grinding conditions are steadily more demanding.

It is an objective of the invention to satisfy this need.

### SUMMARY OF THE INVENTION

According to the invention, this objective is achieved by means of a process for manufacturing a product, comprising the following successive steps:
a) mixing raw materials to form a starting feedstock;
b) melting the starting feedstock so as to form a molten liquid;
c) solidifying the molten liquid so as to obtain a fused product comprising crystals linked by a glassy phase; and
d) crystallization heat treatment of the glassy phase of said fused product.

This process is remarkable in that the composition of the starting feedstock is adapted in order to manufacture a product having the following chemical composition, as weight percentages based on the oxides, and for a total of 100%:
40%≦(ZrO₂+HfO₂)≦94%;
4%<CeO₂<31%;
0%≦Y₂O₃;
0%≦Al₂O₃;
2%≦SiO₂;
0%≦MgO;
0%≦TiO₂; and
other oxides≦1%.

As will be seen further on, the fused product manufactured, hereinbelow “product according to the invention”, has excellent wear resistance.

This result is astonishing. This is because the formation of crystallites within a glassy phase, resulting from the heat treatment of step d) is accompanied by a reduction in the overall volume and generally leads to the creation of porosities, or even of cracks. These porosities and cracks are prejudicial to the mechanical strength.

Without being bound by this theory, the inventors explain the results obtained by the very specific microstructure of the product according to the invention. Specifically, in a product according to the invention, crystallites based on cerium oxide and/or on zirconia and/or on titanium oxide and/or on alumina and/or on yttrium oxide and/or on silica are distributed within the glassy phase, including in the immediate vicinity of dendritic crystals based on zirconia, whereas in the products manufactured according to other processes, the possible crystallites are, on the contrary, substantially absent at the interface between the glassy phase and the dendritic crystals. This distribution of crystallites throughout the entire glassy phase could be explained by the presence of crystallites which, considering the composition of the starting feedstock, would be predominantly of a chemical nature different from the dendritic crystals.

With this distribution of the crystallites throughout the entire glassy phase, the inventors have observed a reduction, or even an elimination, of the cracks or of the pores that are prejudicial to the application.

The crystallization in step d) constitutes a novel route for improving the wear resistance: indeed until the present invention, especially for improving the grinding efficiency, the research attempted exclusively to increase the density of the products, generally in the form of beads, or to modify their chemical composition.

A process according to the invention may also have one or more of the following optional features:
in step a), the composition of the starting feedstock is adapted in order to manufacture a product having a chemical composition such that the SiO₂/Al₂O₃ weight ratio is less than or equal to 1, preferably less than equal to 0.75 and/or greater than 0.3.
between b) and step c), a dispersion of the molten liquid is carried out so as to form droplets.
at the end of step c), the product has a shape, at least one dimension of which is less than 30 mm. In particular, it may have the shape of a bead or of a thin plate.
the heat treatment in step d) comprises a hold at a temperature between 800° C. and 1100° C.
the heat treatment in step d) comprises a hold at a temperature between 800° C. and 950° C., preferably at a temperature between 820° C. and 880° C., and more preferably at 850° C.
the heat treatment in step d) comprises a hold at a temperature between 950° C. and 1100° C., preferably at a temperature between 970° C. and 1070° C., and more preferably at 1000° C.
the hold time, regardless of the temperature of the hold, is greater than or equal to 1 hour, preferably greater than or equal to 2 hours, preferably greater than or equal to 3 hours, preferably greater than or equal to 5 hours, more preferably from 5 to 10 hours, or even is equal to 10 hours.
the heat treatment in step d) only comprises a nucleation operation of the glassy phase at a first temperature above the glass transition temperature T_{g} of the glassy phase of the product resulting from step c), or only comprises a single growth operation of the crystallization seeds at a second temperature, above the glass transition temperature T_{g} of the glassy phase of the product resulting from step c). In the latter case, the crystallization seeds may especially result from the rise in temperature to the second temperature.
the heat treatment in step d) comprises a nucleation operation of the glassy phase of the product at a first temperature above the glass transition temperature T_{g} of the glassy phase of the product resulting from step c), then a growth operation of the crystallization seeds or “nuclei”, created during the nucleation operation, at a second temperature above the first temperature, preferably at least 50° C., at least 80° C., at least 100° C., or even at least 150° C. above the first temperature.
the heat treatment in step d) comprises a hold at a temperature between 820° C. and 880° C., and preferably at around 850° C., followed by a hold at a temperature between 970° C. and 1070° C., and preferably at around 1000° C.
the heat treatment cycle in step d) firstly comprises a hold of 10 hours at 850° C., followed by a hold of 10 hours at 1000° C.
in step d), the rates of rise and fall in temperature are between 15° C./h and 500° C./h, preferably between 20° C./h and 200° C./h. A rate of 120° C./h is very suitable.

Preferably, the process is adapted so that the product according to the invention has one or more of the possibly optional features described below.

The invention also relates to a product obtained or capable of being obtained by means of a process according to the invention. To the knowledge of the inventors, such a product differs from the known products, in particular, by the microstructure described above.

According to embodiments of the invention, the product may also have one or more of the following optional features:
the crystallites are distributed within the glassy phase of the matrix in a substantially homogeneous manner.
the diameter “D” of the larger circle that it is possible to place on a cross-sectional view in the middle of the product, taken using a transmission electron microscope (TEM), without any crystallite being included, even partially, in this circle is preferably less than 3.5 μm, preferably less than 2 μm, more preferably less than 1 μm.
more than 95% by number, or even more than 97% by number, or even more than 99% by number, or even substantially 100% by number of the crystallites distributed in the matrix have a form factor F greater than 0.40, or greater than 0.45, or greater than 0.50, or greater than 0.55, or else greater than 0.60, or even greater than 0.70.
the statistical distribution, which represents the number of grains as a function of their size, is multimodal, and in particular bimodal, a first mode corresponding to the sizes of the crystallites resulting from step d) and a second mode corresponding to the sizes of the dendritic crystals obtained at the end of step c). A bimodal distribution corresponds to a distribution having two main peaks or “first and second modes”. Preferably, the sizes T1 and T2 corresponding to said first and second modes are such that the T2/T1 ratio is greater than 50, preferably greater than 100, preferably greater than 150 or even greater than 200. Preferably, T1 is greater than 5 nm, preferably greater than 10 nm, or even greater than 0.05 μm and less than 0.15 μm. Preferably, T2 is greater than 15 μm and less than 100 μm.
at least 80%, or at least 90%, or even substantially 100% by number of the dendritic crystals have a size greater than or equal to 2 μm, or greater than or equal to 3 μm, or greater than or equal to 5 μm, or greater than or equal to 10 microns, or else greater than or equal to 15 microns and/or have a size less than or equal to 100 microns.
at least 80%, or at least 90%, or even substantially 100% by number of the crystallites distributed in the glassy phase have a size of less than or equal to 400 nm, or less than or equal to 300 nm, or less than or equal to 250 nm, or else less than or equal to 200 nm, or even less than or equal to 150 nm and/or have a size greater than or equal to 5 nm, or greater than or equal to 10 nm, or greater than or equal to 15 nm, or greater than or equal to 20 nm, or greater than or equal to 30 nm, or greater than or equal to 40 nm, or even greater than 50 nm.
the crystallites distributed in the glassy phase are not of dendritic form.
the SiO₂/Al₂O₃ weight ratio is less than or equal to 1, preferably less than or equal to 0.75 and/or greater than 0.3.
the product is in the form of a bead having a size of less than or equal to 4 mm and/or greater than or equal to 5 μm.
the product is in the form of a powder, the maximum size D_{99.5} of which is preferably less than 5 mm.

The invention also relates to the use of a product according to one embodiment of the invention, for example obtained following a process that conforms to the invention, as a grinding agent, as an agent for dispersing in a wet medium or for surface treatment.

It relates, in particular, to the use of a product according to one embodiment of the invention, for example obtained following a process that conforms to the invention, as an agent for grinding suspensions having a pH>8, for example suspensions of calcium carbonate CaCO₃.

### DEFINITIONS

The term “particle” is understood to mean an individualized solid product in a powder.
The term “bead” is understood to mean a particle having a sphericity that is to say a ratio between its smallest diameter and its largest diameter greater than or equal to 0.6, regardless of the way in which this sphericity was obtained. Preferably, the beads according to the invention have a sphericity greater than or equal to 0.7, preferably greater than 0.8, more preferably greater than 0.9.
The term “crystal” is understood to mean a region of matter obtained by translation of the unit cell of a crystalline structure in the three directions of space and having a size greater than or equal to 1 micron.
The term “twin” is understood to mean an oriented combination of two or more identical crystals. In the remainder of this description, and for the sake of simplification, the term “crystal” is used for a crystal or a twin.
Conventionally, the term “dendrite” is used to describe a crystal obtained after growth of a seed and has a fractal or pseudo-fractal geometry. The methods of obtaining dendritic crystals are well known to a person skilled in the art. The tests below provide examples of methods that make it possible to obtain dendritic crystals.
The term “crystallite” is understood to mean an area of material having the same structure as a crystal but having a size of less than 1 micron.
The term “grains” here refers to all crystals and crystallites.
The term “matrix” is understood to mean a binder phase providing a continuous structure between the crystals. In a product of the invention, the matrix comprises a glassy phase within which crystallites are distributed. The possible pores are not part of the matrix. The “crystallization” or the “degree of crystallization” of the matrix refer to these crystallites.
It is considered that the crystallites are “distributed” within the glassy phase when they are present throughout the entire glassy phase, and especially in the vicinity of the crystals. To the knowledge of the inventors, the crystallization heat treatment of step d) is necessary in order to obtain distributed crystallites.
The expression “glass transition temperature” of a glassy phase is understood to mean the middle of the temperature range in which said glassy phase becomes gradually more viscous and passes from the liquid state to the solid state. It is commonly acknowledged that this temperature corresponds to the temperature for which the viscosity of the glassy phase is 10¹³ Poise. The glass transition temperature of the glassy phases may be determined by differential scanning calorimetry (DSC).
It is possible to evaluate the homogeneity of the distribution of crystallites in the glassy phase by the diameter “D” of the largest circle that it is possible to place in a cross-sectional view in the middle of the product, taken using a transmission electron microscope (TEM), without any crystallite being included, even partially, in this circle. This diameter thus represents the largest possible circular space between the crystallites observed. A high diameter “D” means that there is a large disc-shaped zone that is free of crystallites, which corresponds, for the same degree of coverage of the matrix by the crystallites, to a lower homogeneity of the spatial distribution of the crystallites.
The “degree of coverage” DC of the matrix by the crystallites is measured, on a cross-sectional image in the middle of the product taken using a scanning electron microscope (SEM), by the ratio of the surface area occupied by the crystallites “S_{C}” to the total surface area of the matrix (glassy phase+crystallites) “S_{T}”. Thus, DC═S_{C}/S_{T}, Preferably, the dimensions are measured using imaging processing software, such as for example ELLIX sold by MICROVISION.
The percentiles or “centiles” 99.5 (D_{99.5}) and 50 (D₅₀) are the sizes of particles of a powder corresponding to the percentage of 99.5% and 50%, respectively, by weight on the accumulated particle size distribution curve of the sizes of the particles of the powder, the particle sizes being classified in increasing order. For example, 99.5% by weight of the particles of the powder have a size below D_{99.5} and 0.5% of the particles by weight have a size greater than D_{99.5}. The percentiles may be determined using a particle size distribution produced using a SediGraph, using a laser particle size analyser or using screening through a series of screens.
The “size” of a particle, especially of a bead, is referred to as the average of its largest dimension dM and of its smallest dimension dm: (dM+dm)/2.
The “size” of a crystal, for example in the form of a dendrite, and the size of a crystallite are defined by the average of the length of the smallest axis “Pa”, respectively “Pa′” and of the length of the largest axis “Ga”, respectively “Ga′” of the ellipse of minimal area in which said crystal and said crystallite may be inscribed in a section of the product: (Pa+Ga)/2, (Pa′+Ga′)/2, respectively. Conventionally, the size of a crystal is measured on photographic images taken using a scanning electron microscope (SEM), on a polished section of the product, and the size of the crystallite is measured on photographic images taken using a transmission electron microscope (TEM), on a polished section of the product. Preferably, the dimensions are measured using image processing software, such as for example VISILOG sold by NOESIS.
The form factor “F” of a crystallite is understood to mean the ratio between the length of the smallest axis “Pa′” and the length of the largest axis “Ga” of the ellipse having a minimal area in which the shape of the crystallite, observed in one section of the product, may be inscribed. Conventionally, these lengths are measured on photographic images taken on a polished section of the product: F=Pa′/Ga′.
The expression “elongated shape” is understood here to mean a shape having a form factor F of less than 0.4.
The expression “globular shape” is understood here to mean a shape having a form factor F greater than or equal to 0.4.
The expression “fused product” is understood to mean a product obtained by solidification by cooling of molten liquid.
A “molten liquid” is a liquid mass which may contain some solid particles, but in an insufficient quantity for them to be able to structure said mass. Material undergoing a sintering in the liquid phase cannot be considered to be a molten liquid.
The term “impurities” is understood to mean the inevitable constituents inevitably introduced with the raw materials. In particular, the compounds belonging to the group of oxides, nitrides, oxynitrides, carbides, oxycarbides, carbonitrides and metal species of sodium and other alkali metals, iron, vanadium and chromium are impurities. By way of example, mention may be made of CaO, Fe₂O₃ or Na₂O. The residual carbon is part of the impurities of the composition of the products according to the invention.
“Zirconia” refers to zirconium oxide ZrO₂. When reference is made to ZrO₂ or to (ZrO₂+HfO₂), it should be understood as zirconia and traces of hafnium oxide. This is because a small amount of HfO₂, chemically indissociable from ZrO₂ in a melting process and having similar properties, is always naturally present in zirconia sources at contents generally of less than 2%. Hafnium oxide is then not considered to be an impurity.
The term “precursor” of an oxide is understood to mean any product which, during melting, will decompose giving at least said oxide. MgCO₃ is, for example, a precursor of the oxide MgO. This is because, during melting, MgCO₃ will decompose to MgO and CO₂.
A material is said to be “based” on a constituent when this constituent is the main constituent, by weight, of said material.
All the percentages of the present description are percentages by weight based on the oxides, unless otherwise indicated.

### BRIEF DESCRIPTION OF THE FIGURES

Other features and advantages will also appear on reading the description which follows and on examining the appended figures in which:

FIG. 1 is a photograph taken with a scanning electron microscope (or SEM) of a particle of Example 23;

FIG. 2 is a photograph taken with a transmission electron microscope (or TEM) of the matrix of a particle of Example 6; and

FIG. 3 is a photograph taken with a transmission electron microscope (or TEM) of the matrix of a particle of Example 5.

### DETAILED DESCRIPTION

Process

To fabricate a product according to an embodiment of the invention, the steps a) to d) mentioned above can be carried out.

A preferred embodiment of this process is now described.

In step a), the starting process feedstock is formed of the oxides desired in the product or of precursors thereof. Preferably, to fabricate a product based on zirconia, natural zircon sand ZrSiO₄ is used, containing about 66% of ZrO₂ and 33% of SiO₂, plus impurities. The addition of ZrO₂ via zircon is in fact much more economical than an addition of ZrO₂.

The compositions can be adjusted by adding pure oxides, mixtures of oxides or mixtures of precursors of these oxides, in particular ZrO₂+HfO₂, SiO₂, CeO₂, Y₂O₃, TiO₂, Al₂O₃, and MgO.

A person skilled in the art adjusts the composition of the starting feedstock in order to obtain, on completion of step c), a product having the desired chemical analysis. The chemical analysis of a fused ceramic product is generally substantially identical to that of the starting feedstock. Furthermore, if necessary, for example to take account of the presence of volatile oxides, or to take account of the loss of SiO₂ when the fusion is carried out under reducing conditions, a person skilled in the art knows how to adjust the composition of the starting feedstock accordingly.

Preferably, no oxide other than ZrO₂+HfO₂, SiO₂, CeO₂, Y₂O₃, TiO₂, Al₂O₃, and MgO is introduced intentionally, in the form of oxide or oxide precursor, into the starting feedstock, the other oxides present being impurities.

Preferably, the starting feedstock is prepared so that, in the product manufactured, the MgO/SiO₂ weight ratio is less than or equal to 1, preferably less than or equal to 0.77, and the SiO₂/Al₂O₃ weight ratio is less than or equal to 1, preferably less than or equal to 0.75 and/or greater than 0.3.

In step b), the starting feedstock is melted, preferably in an electric arc furnace. The electrofusion serves in fact to produce large quantities of particles with advantageous yields. However, all known furnaces may be used, such as an induction furnace or a plasma furnace, provided that they are suitable for melting the starting feedstock to form a molten liquid bath.

In step c), a stream of the molten liquid is dispersed in small liquid droplets, most of which, due to the surface tension, assume a substantially spherical shape. This dispersion can be carried out by blowing, particularly with air and/or steam, or by any other method for spraying a molten liquid, known to a person skilled in the art. A fused ceramic particle having a size of 5 μm to 4 mm may thus be produced.

The cooling resulting from the dispersion leads to the solidification of the liquid droplets. Fused particles are thereby obtained, in particular beads.

Any conventional process for fabricating fused particles, particularly fused beads, can be used. These fused particles may be ground in order to modify their particle size distribution.

At the end of step c), the particles comprise dendritic crystals linked by a matrix that is substantially non-crystalline, especially in the immediate vicinity of the dendritic crystals.

In step d), the particles obtained in step c) are subjected to a heat treatment. In one embodiment, this heat treatment is applied, at the end of step c), to particles cooled to a temperature below the nucleation temperature, for example to ambient temperature. The heat treatment then involves a rise in temperature. But it is also possible, according to another embodiment, to apply the heat treatment during the cooling of the particles, that is to say to temporarily stabilize the temperature in order to carry out one or more nucleation or growth holds, and therefore to group together the steps c) and d).

The rates of rise and fall in temperature may be, for example, between 10° C./h and 1200° C./h, preferably between 15° C./h and 500° C./h, preferably between 20° C./h and 200° C./h. A rate of 120° C./h is particularly suitable.

The heat treatment may comprise a single temperature hold.

In one embodiment, the heat treatment comprises a hold at a temperature between 800° C. and 950° C., preferably at a temperature between 820° C. and 880° C., and more preferably at 850° C., for a time greater than or equal to 1 hour, preferably greater than or equal to 2 hours, preferably greater than or equal to 3 hours, more preferably greater than or equal to 5 hours. A hold time ranging from 5 to 10 hours, or even equal to 10 hours, is particularly suitable.

In one embodiment, the heat treatment comprises a hold at a temperature between 950° C. and 1100° C., preferably at a temperature between 970° C. and 1070° C., and more preferably at 1000° C., for a time greater than or equal to 1 hour, preferably greater than or equal to 2 hours, preferably greater than or equal to 3 hours, more preferably greater than or equal to 5 hours. A hold time ranging from 5 to 10 hours, or even equal to 10 hours, is particularly suitable.

Preferably, the heat treatment cycle comprises two holds.

Preferably, the first hold is determined in order to generate crystallization seeds in the glassy phase and the second hold is determined in order to make the seeds grow. The temperature of the second hold is greater than that of the first hold, preferably at least 50° C., at least 80° C., at least 100° C. or even at least 150° C. greater than the temperature of the first hold.

In one embodiment, the first hold is at a temperature between 800° C. and 950° C., preferably at a temperature between 820° C. and 880° C., and more preferably at 850° C., and the second hold is at a temperature between 950° C. and 1100° C., preferably at a temperature between 970° C. and 1070° C., and more preferably at 1000° C.

Preferably, the temperature hold time of at least one of the first and second holds, preferably of each of these two holds, is greater than or equal to 1 hour, preferably greater than or equal to 2 hours, preferably greater than or equal to 3 hours, more preferably greater than or equal to 5 hours. For each of the two holds, a hold time ranging from 5 to 10 hours, or even equal to 10 hours, is particularly suitable. A hold time greater than or equal to 10 hours is however possible.

In one most preferred of all embodiment, the heat treatment comprises a first hold at 850° C. for a time ranging from 5 to 10 hours, or even equal to 10 hours, followed by a hold at 1000° C., for a time ranging from 5 to 10 hours, or even equal to 10 hours.

The implementation of a heat treatment after the solidification makes it possible to control the generation of crystallites, and especially to determine the degree of crystallization and/or to adjust the size of the crystallites: thus, the inventors have observed that the majority of crystallites are created during the first hold or, when the heat treatment comprises a single hold, during the rise in temperature. The duration of these phases therefore determines the number of crystallites, a longer duration corresponding to a greater amount of crystallites. This observation also led the inventors to recommend the use of two holds, the control of the creation of crystallites being improved thereby.

The inventors have also observed that the size of the crystallites increases with the temperature of the second hold.

Other processes for manufacturing a product according to the invention may be envisaged. For example, it is possible to manufacture a fused product that is cast in the form of a plate, preferably with rapid cooling, as described, for example, in FR 2 290 266, incorporated by reference, then to grind it and, if necessary, to carry out a particle size selection, then to subject the powder obtained to a crystallization heat treatment such as described in step d) described previously. As a variant, said heat treatment may be carried out before grinding.

The form of the fused product is preferably adapted in order to facilitate the crystallization in step d). Specifically, if the form of the product is too massive, for example if the product is in the form of a brick of several kilos, the crystallization will only be able to be effective, according to current techniques, on the surface of the product. Preferably, the fused product has at least one of its dimensions below 30 mm, preferably below 20 mm, preferably below 10 mm, more preferably below 5 mm, preferably below 2 mm. Preferably, the product has the form of a thin plate having a thickness of less than 30 mm, preferably less than 20 mm, preferably less than 10 mm, more preferably less than 5 mm, preferably less than 2 mm.

Products

A product according to the invention is preferably in the form of a particle, or even a bead, or an assembly of particles, or of beads. These beads and particles may have a size of less than or equal to 4 mm and/or greater than or equal to 5 μm.

The content of oxides in the composition of a product according to the invention may represent more than 99.5%, or even more than 99.9%, and even substantially 100% of the total weight of the product.

The ZrO₂ content, in weight percent based on the oxides, may be greater than or equal to 45% and/or less than or equal to 90%.

According to one embodiment, the ZrO₂ content, in weight percent based on the oxides, may be greater than or equal to 50%, or greater than or equal to 55%, or else greater than or equal to 60% and/or less than or equal to 85%, or less than or equal to 80%, or less than or equal to 75%, or else less than or equal to 70%.

As indicated previously, the CeO₂ content of a fused product according to the invention is less than 31%, in weight percent based on the oxides. The CeO₂ content, in weight percent based on the oxides, may be greater than or equal to 5%.

According to one embodiment, the CeO₂ content, in weight percent based on the oxides, may be greater than or equal to 6%, or greater than or equal to 8%, or greater than or equal to 10%, or greater than or equal to 12%, or greater than or equal to 15%, or greater than or equal to 17%, or even greater than or equal to 19% and/or less than or equal to 30%, or less than or equal to 28%, or even less than or equal to 26%.

The Y₂O₃ content, in weight percent based on the oxides, may be greater than or equal to 0.1% and/or less than or equal to 10%.

According to one embodiment, the Y₂O₃ content, in weight percent based on the oxides, may be greater than or equal to 0.5%, or greater than or equal to 1%, or greater than or equal to 1.5%, or greater than or equal to 2%, or else greater than or equal to 2.5%, or even greater than or equal to 3% and/or less than or equal to 8%, or less than or equal to 6%, or less than or equal to 5.5%, or less than or equal to 5%.

The SiO₂ content, in weight percent based on the oxides, may be greater than or equal to 2% or greater than or equal to 3% and/or less than or equal to 40%.

According to one embodiment, the SiO₂ content, in weight percent based on the oxides, may be greater than or equal to 4%, or even greater than or equal to 5% and/or less than or equal to 35%, or less than or equal to 30%, or less than or equal to 20%, or less than or equal to 18%, or less than or equal to 16%, or less than or equal to 14%, or less than or equal to 12%, or less than or equal to 10%, or else less than or equal to 8%.

The Al₂O₃ content, in weight percent based on the oxides, may be greater than or equal to 0.5% and/or or less than or equal to 25%.

According to one embodiment, the Al₂O₃ content, in weight percent based on the oxides, may be greater than or equal to 1%, or greater than or equal to 2%, or greater than or equal to 4% and/or less than or equal to 20%, or less than or equal to 15%, or less than or equal to 12%.

The TiO₂ content, in weight percent based on the oxides, may be greater than or equal to 0.5% and/or less than or equal to 8.5%.

The presence of TiO₂ may advantageously promote the homogeneity of the distribution of the crystallites in the matrix.

According to one embodiment, the TiO₂ content, in weight percent based on the oxides, may be greater than or equal to 1%, or else greater than or equal to 1.25%, or even greater than or equal to 1.5% and/or less than or equal to 5%, or less than or equal to 3%, or even less than or equal to 2%.

The MgO/SiO₂ weight ratio is preferably less than or equal to 1, more preferably less than or equal to 0.77.

According to one embodiment, the MgO content, in weight percent based on the oxides, may be greater than or equal to 0.5%, or greater than or equal to 1%, or else greater than or equal to 1.25%, or even greater than or equal to 1.5%, and/or less than or equal to 4%, or less than or equal to 3.2%.

Preferably, the (ZrO₂+HfO₂)/SiO₂ weight ratio is greater than or equal to 1, or greater than or equal to 1.5, or greater than or equal to 2, or else greater than or equal to 2.5 and/or less than or equal to 25, or less than or equal to 20, or else less than or equal to 15, or even less than or equal to 10.

According to one embodiment, the SiO₂/Al₂O₃ weight ratio is less than or equal to 1, preferably less than or equal to 0.75 and/or greater than 0.3.

The content of “other oxides”, that is to say the oxides other than the aforementioned oxides, is preferably less than 1%, or even less than or equal to 0.6% of the total weight of oxides. Specifically, it is considered that a total content of “other oxides” of less than 1% does not substantially modify the results obtained.

The other oxides are especially oxides such as CaO, Na₂O, P₂O₅ or Fe₂O₃.

Preferably, the “other oxides” are only present in the form of impurities.

As represented in FIG. 1, a product according to one embodiment of the invention, for example obtained according to a process conforming to the invention, comprises dendritic crystals 10 linked by a matrix 11.

The dendritic crystals 10 represented are isolated from one another. They may also however be in contact, or even overlapped with one another. They then advantageously form a skeleton that is difficult to deform.

The dendritic crystals 10 are based on zirconia. Their composition may especially comprise at least 60 mol %, or at least 70 mol %, or at least 80 mol % of zirconia.

The measurement of the length of the smallest axis “Pa” and the length of the largest axis “Ga” of the ellipse “E” of minimal area in which a dendritic crystal 10 can be inscribed makes it possible to obtain its size L, equal to (Pa+Ga)/2.

At least 80%, or 90%, or even substantially 100% by number of the dendritic crystals may have a size greater than or equal to 2 microns.

According to one embodiment, at least 80%, or 90%, or even substantially 100% by number of the dendritic crystals have a size greater than or equal to 3 microns, or greater than or equal to 5 microns, or greater than or equal to 10 microns, or else greater than or equal to 15 microns and/or a size less than or equal to 100 microns.

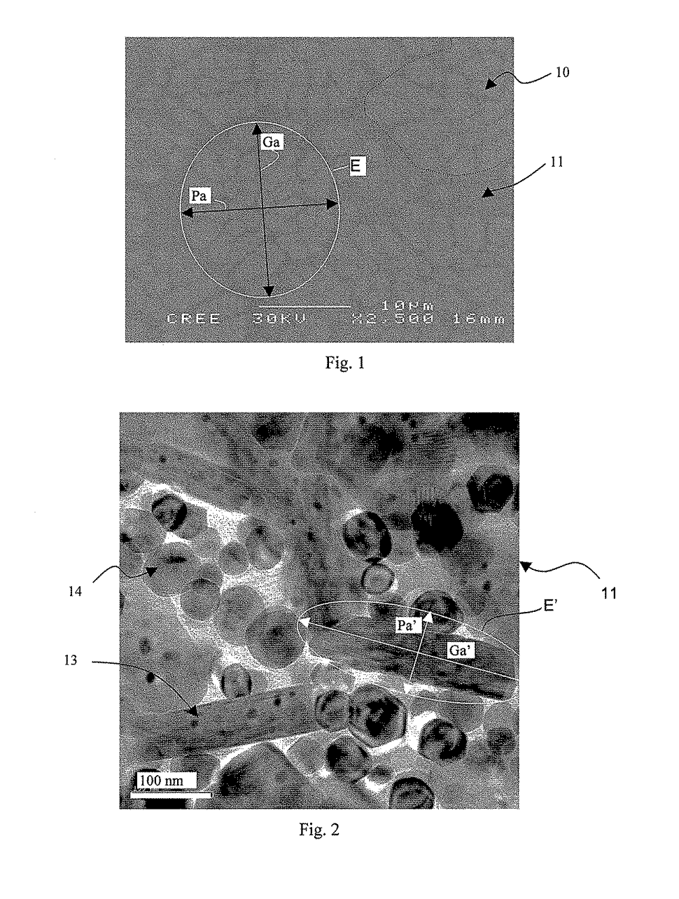

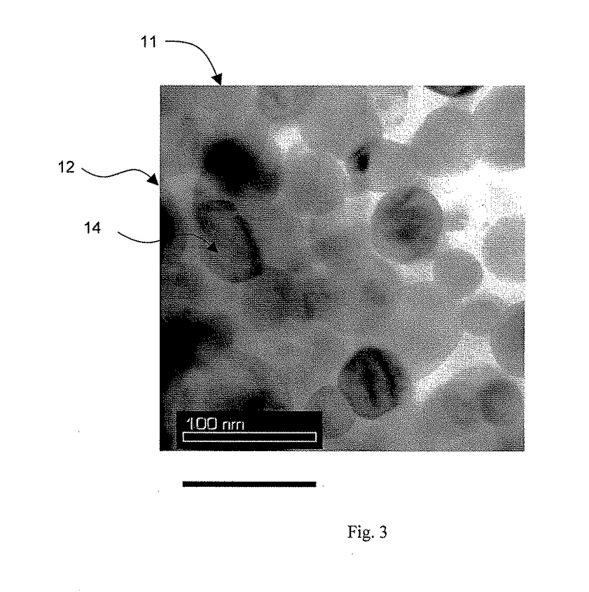

As represented in FIGS. 2 and 3, the matrix 11 comprises a glassy phase 12 in which crystallites 13 and 14 are distributed.

Depending on the crystallization conditions, the crystallites may have varied shapes, especially elongated shapes (crystallite 13) or globular shapes (crystallite 14).

According to one embodiment, the crystallites are not of dendritic form.

As indicated in FIG. 2, the form factor F and the size of a crystallite may be determined by inscribing the shape of this crystallite in an ellipse E′ of minimal area, and by then measuring the length of the smallest axis Pa′ and that of the largest axis Ga′. The size 1.1 is equal to (Pa′+Ga′)/2. The form factor F is equal to Pa′/Ga′.

According to one embodiment, more than 95% by number, or even more than 97% by number, or even substantially 100% by number of the crystallites distributed in the matrix have a form factor F greater than 0.40, or greater than 0.45, or greater than 0.50, or greater than 0.55, or else greater than 0.60, or even greater than 0.70.

At least 80%, or 90%, or even substantially 100% by number of the crystallites distributed in the matrix may have a size of less than or equal to 400 nm.

According to one embodiment, at least 80%, or 90%, or even substantially 100% by number of the crystallites distributed in the matrix have a size of less than or equal to 300 nm, or less than or equal to 250 nm, or else less than or equal to 200 nm, or even less than or equal to 150 nm and/or a size greater than or equal to 5 nm, or greater than or equal to 10 nm, or greater than or equal to 15 nm, or greater than or equal to 20 nm, or greater than or equal to 30 nm, or greater than or equal to 40 nm, or even greater than 50 nm.

As indicated previously, a fused product conforming to the invention comprises dendritic crystals linked by a matrix within which crystallites are distributed.

The crystallites may be distributed within the glassy phase of the matrix in a substantially homogeneous manner. Preferably, the diameter “D” defined above is less than 3.5 μm, preferably less than 2 μm, more preferably less than 1 μm.

The crystallites may contain one or more crystalline phases, for example crystalline phases based on cerium oxide and/or on zirconia and/or on titanium oxide and/or on alumina and/or on yttrium oxide and/or on silica.

They may also contain crystalline phases of compounds comprising several metal oxides, such as for example cerium oxide-zirconia compounds or cerium oxide-yttrium oxide-zirconia compounds.

The crystallites may represent, in a view of a section in the middle of a product of the invention, more than 15%, or even more than 30%, or even more than 40%, or even more than 60%, or even more than 70%, or even more than 80% of the surface area of the matrix (glassy phase+crystallites). In other words, the degree of coverage of the matrix by the crystallites may be greater than 15%, or even greater than 30%, or even greater than 40%, or even greater than 60%, or even greater than 70%, or even greater than 80%.

In one embodiment of the invention, a fused product may have the following chemical composition, as weight percentages based on the oxides, and for a total of 100%:
40%≦(ZrO₂+HfO₂)≦94%;
4%<CeO₂<31%;
0%≦Y₂O₃;
0%≦Al₂O₃;
2%≦SiO₂;
0%≦MgO;
0%≦TiO₂; and
other oxides≦1%,
   and comprise dendritic crystals linked by a matrix within which the crystallites are distributed.

According to a first particular embodiment, that is particularly suitable for obtaining a high planetary wear resistance, the composition of a product according to the invention is such that, for a total of 100%:
45%≦(ZrO₂+HfO₂)≦85%;
6%≦CeO₂<31%;
0.8%≦Y₂O₃≦8.5%;
0%≦Al₂O₃≦30%;
2%≦SiO₂≦37%;
0≦MgO≦6%;
0≦TiO₂≦8.5%; and
other oxides≦1%.

Preferably, by denoting the CeO₂/(ZrO₂+HfO₂) weight ratio as “C” and the Y₂O₃/(ZrO₂+HfO₂) weight ratio as “Y”:
0≦C≦0.6 and 0.02≦Y≦0.098 and
when Y<0.082, Min (63.095 Y²−11.214 Y+0.4962; 0.25)≦C and
C≦250 Y²−49.1 Y+2.6.

Preferably, 0≦C≦0.6 and 0.02≦Y≦0.098 and when Y<0.082, Min (70.238 Y²−12.393 Y+0.544; 0.25)≦C.

More preferably, 0≦C≦0.6 and 0.02≦Y≦0.098 and when Y<0.089, Min (−38.095 Y²+0.3571 Y+0.2738; 0.25)≦C.

Preferably, 0≦C≦0.6 and 0.02≦Y≦0.098 and C≦150 Y²−30.7 Y+1.72, more preferably, C≦−51.1905 Y²+0.25 Y+0.4826.

More preferably, the CeO₂/(ZrO₂+HfO₂) weight ratio is greater than or equal to 0.2, preferably greater than or equal to 0.3 and/or less than or equal to 0.5.

Still preferably, the Y₂O₃/(ZrO₂+HfO₂) weight ratio is greater than or equal to 0.03, preferably greater than or equal to 0.045 and/or less than or equal to 0.09, preferably less than or equal to 0.06.

The features described previously within the general context of the invention can be applied to this first particular embodiment, as long as they are not incompatible with it.

According to a second particular embodiment, the composition of a product according to the invention is such that, for a total of 100%:
55%≦ZrO₂+HfO₂≦75%;
10%≦CeO₂≦30%;
1.5%≦Y₂O₃≦5%;
0%≦Al₂O₃≦15%, preferably 4%≦Al₂O₃≦12%;
3%≦SiO₂≦12%, preferably SiO₂≧5%;
0%≦MgO≦2%;
0%≦TiO₂≦5%, preferably TiO₂≧1.5%; and
other oxides<1%.

In this embodiment, it is particularly advantageous, especially in an application in a basic medium, for the diameter “D” as defined above to be less than 3.5 μm.

Preferably, a product conforming to this second particular embodiment has one or more of the following optional features:
the SiO₂/Al₂O₃ weight ratio is less than or equal to 1, preferably less than or equal to 0.75 and/or greater than 0.3: the glassy phase is then rich in alumina.
the SiO₂/Al₂O₃ weight ratio is less than or equal to 1, preferably less than or equal to 0.75 and/or greater than 0.3, and SiO₂>5%: the glassy phase is then abundant and rich in alumina.
more than 95% by number, preferably more than 97% by number, preferably more than 99% by number, and more preferably substantially 100% by number of the crystallites have a form factor F greater than 0.45, or greater than 0.50, or greater than 0.55, or else greater than 0.60, or even greater than 0.70.
the diameter “D” is less than 2 μm, preferably less than 1 μm.
by denoting the CeO₂/(ZrO₂+HfO₂) weight ratio as “C” and the Y₂O₃/(ZrO₂+HfO₂) weight ratio as “Y”:
   0≦C≦0.6 and 0.02≦Y≦0.098 and
   when Y<0.082, Min (63.095 Y²−11.214 Y+0.4962; 0.25)≦C and
   C≦250 Y²−49.1 Y+2.6.
more preferably, 0≦C≦0.6 and 0.02≦Y≦0.098 and when Y<0.082, Min (70.238 Y²−12.393 Y+0.544; 0.25)≦C, preferably when Y<0.089, Min (−38.095 Y²+0.3571 Y+0.2738; 0.25)≦C
more preferably, 0≦C≦0.6 and 0.02≦Y≦0.098 and C≦150 Y²−30.7 Y+1.72, still preferably C≦−51.1905 Y²+0.25 Y+0.4826.
the CeO₂/(ZrO₂+HfO₂) weight ratio is greater than or equal to 0.2, preferably greater than or equal to 0.3 and/or less than or equal to 0.5.
the Y₂O₃/(ZrO₂+HfO₂) weight ratio is greater than or equal to 0.03, preferably greater than or equal to 0.045 and/or less than or equal to 0.09, preferably less than or equal to 0.06.

The features described previously in the general context of the invention can be applied to this second particular embodiment, as long as they are not incompatible with it.

The inventors have discovered that a product according to the second particular embodiment has, in a strongly basic medium, a particularly high corrosion resistance.

Without being able to explain it, the inventors have observed that these performances correspond, on a view taken with a transmission electron microscope, to a percentage below 5% by number of crystallites having a form factor of less than 0.4 (that is to say of elongated shape).

A subset of the products according to this second particular embodiment has the following chemical composition, for a total of 100%:
55%≦ZrO₂+HfO₂≦75%;
10%≦CeO₂≦30%;
1.5%≦Y₂O₃≦5%;
5%≦SiO₂≦12%;
4%≦Al₂O₃≦12%;
0%≦MgO≦2%;
1.5%≦TiO₂≦3%; and
other oxides<1%.
   Preferably, the matrix has a diameter “D” of less than 1 μm.

Preferably, a product conforming to this subset of this second particular embodiment has one or more of the following optional features:
more than 99% by number, and more preferably substantially 100% by number of the crystallites have a form factor F greater than 0.50, preferably greater than 0.55, preferably greater than 0.60, preferably greater than 0.70.
by denoting the CeO₂/(ZrO₂+HfO₂) weight ratio as “C” and the Y₂O₃/(ZrO₂+HfO₂) weight ratio as “Y”:
   0≦C≦0.6 and 0.02≦Y≦0.098 and
   when Y<0.082 Min (63.095 Y²−11.214 Y+0.4962; 0.25)≦C and
C≦250 Y²−49.1 Y+2.6.
preferably, 0≦C≦0.6 and 0.02≦Y≦0.098 and when Y<0.082, Min(70.238 Y²−12.393 Y+0.544; 0.25)≦C, preferably when Y<0.089, Min(−38.095 Y²+0.3571 Y+0.2738; 0.25)≦C.
preferably, 0≦C≦0.6 and 0.02≦Y≦0.098 and C≦150 Y²−30.7 Y+1.72, preferably C≦−51.1905 Y²+0.25 Y+0.4826.
the CeO₂/(ZrO₂+HfO₂) weight ratio is greater than or equal to 0.2, preferably greater than or equal to 0.3 and/or less than or equal to 0.5.
the Y₂O₃/(ZrO₂+HfO₂) weight ratio is greater than or equal to 0.03, preferably greater than or equal to 0.045 and/or less than or equal to 0.09, preferably less than or equal to 0.06.

In the case of stresses in a highly basic medium, that is to say for pH values>8, for example for the grinding of calcium carbonate suspensions, such products are particularly suitable because they have a high wear resistance coupled to a good resistance to the chemical attack of the medium in which the grinding is carried out.

Regardless of the embodiment, a product according to the invention preferably has a density greater than or equal to 4, or greater than or equal to 4.5, or greater than or equal to 4.7, or else greater than or equal to 5, or even greater than or equal to 5.2. Specifically, it is considered that the higher the density, the better the grinding efficiency.

Planetary wear and wear in a basic medium are defined below.

The product may have a wear in a basic medium of less than or equal to 2.2 g/h, or less than or equal to 2 g/h, or less than or equal to 1.8 g/h, or less than or equal to 1.5 g/h.

Preferably, the product has a wear in a basic medium of less than or equal to 1.8 g/h and a density greater than or equal to 5.2.

The product may also have a planetary wear of less than or equal to 3.5%, or less than or equal to 2.9%, or less than or equal to 2.5%, or less than or equal to 2.3%, or less than or equal to 2.1%, or even less than or equal to 1.8%.

Depending on the desired properties, a product according to the invention may be used in applications other than grinding in a wet medium. For example, it may be used as a dry grinding agent, a support agent and a heat-exchange agent.

Tests

Measurement Protocols

The density of the products tested is measured by a method using a helium pycnometre (AccuPyc 1330 from Micromeritics®), according to a method based on the measurement of the volume of gas (in the present case helium) that is displaced.

The homogeneity of the distribution of the crystallites in the glassy phase is determined using observations made using transmission electron microscopy (TEM) in the following manner. The preparation of the samples intended to be observed consists in mechanically thinning a particle by successive polishing operations until a thickness of around 30 μm is reached. Then the preparation of the sample is finalized by ion thinning (argon sputtering) using a PIPS (precision ion polishing system). The sample to be observed is then in the form of a foil.

This foil is deposited in the transmission electron microscope (Philips CM 30-300 kV), on a molybdenum support and a copper ring. The purpose of the electron bombardment is to be able to observe the sample in transmission.

At least 5 photos of the microstructure are taken at various zones of the sample chosen randomly. The enlargements of the photos are adapted in order to be able to observe matrix surface areas between 15 and 150 μm² and so that the sum of the surface areas observed is at least 450 μm². The enlargement is adapted so as to clearly distinguish the crystallites in the matrix.

A circle of a given diameter is then moved over the entire matrix surface area observed, seeking a position in which no crystallite is included, even partially, within the circle.
If such a position is found, the operation is repeated with a circle having a diameter 0.1 μm greater than the preceding circle. This procedure is continued until a position that meets the aforementioned criterion is no longer found. The diameter “D” is then equal to the diameter of the circle of the preceding cycle, that is to say to the diameter of the largest circle that it was possible to place on the observed surface area without any crystallite being included, even partially, within this circle.
Similarly, if such a position cannot be found, the diameter of the circle tested is reduced by 0.1 μm and the operation is repeated until a circle that meets the aforementioned criterion is found. The diameter “D” is then equal to the diameter of this last circle.

The photos also make it possible to measure the size of the crystallites and the form factors.

The following methods allow an excellent simulation of the actual behaviour, during service, in the grinding applications.

In order to determine the wear resistance known as “planetary” wear resistance, 20 ml (volume measured using a graduated cylinder) of particles to be tested, selected by screening between 0.8 and 1 mm through square-mesh screens, are weighed (weight m₀) and introduced into one of 4 bowls having a capacity of 125 ml, which are coated with alumina and fastened to the plate of a RETSCH brand PM400 type rapid planetary mill. 2.2 g of Presi brand silicon carbide (having a median size D₅₀ of 23 μm) and 40 ml of water are added to the bowl. The bowl is sealed and the plate is rotated at 400 rpm with reversal of the direction of rotation at one minute intervals for 1 h 30 minutes. The plate is driven by a rotational movement relative to the housing of the mill and the bowl is driven by a rotational movement relative to the plate, set by the rotational speed of the plate. The contents of the bowl is then washed over a 100 μm sieve so as to remove the residual silicon carbide and also any material removed due to wear during the grinding operation. The particles are then dried in an oven at 100° C. for 3 h, then weighed (mass m).

The planetary wear, expressed as a percentage, is given by the following formula:

100(m₀−m)/m

In order to determine the wear known as “wear in a basic medium”, that is to say wear in media having a pH greater than 8, a charge of particles to be tested is screened between 0.6 and 0.8 mm through square-mesh screens. A bulk volume of 1.04 l of particles is weighed (mass m₀). The particles are then introduced into a Netzsch LME1 type horizontal mill (working volume of 1.2 l) having off-centre steel discs. An aqueous suspension of calcium carbonate CaCO₃, having a pH equal to 8.2, containing 70% of solids and of which 40% of the grains by volume are less than 1 μm, passes continuously through the mill, with a throughput of 4 litres an hour. The mill is started gradually until a linear speed at the end of the discs of 10 m/s is achieved. The mill is kept in operation for a time t, between 16 and 24 hours, then stopped. The particles are rinsed with water, carefully removed from the mill then washed and dried. They are then weighed (mass m), The rate of wear V in grams/hour is determined as follows:

V=(m₀−m)/t

The charge of particles is taken up and topped up with (m₀−m) grams of new particles so as to repeat the grinding operation as many times as necessary (n times) so that the accumulated grinding time is at least 100 hours and the difference between the rate of wear calculated in step n and in step n−1 is less than 15% in proportion. Typically, the total grinding time is between 100 hours and 140 hours. The wear is basic medium is the rate of wear measured for the last grinding operation n.

The percentage improvement relative to the comparative example 3 is defined by the following formula: 100×(wear of the product from comparative example 3−wear of the product in question)/wear of the product from comparative example 3. It is considered that the results are particularly satisfactory if the products have an improvement in the wear resistance of at least 10% relative to that of the comparative example 3.

It is considered that the results are particularly satisfactory if the products have an improvement in the resistance to wear in a basic medium of at least 15% relative to that of the comparative example 2.

Manufacturing Protocol

A starting feedstock is prepared from powders of zircon, yttrium oxide, cerium oxide, aluminium oxide and optionally zirconium oxide (zircon's) and titanium oxide. Then, this starting feedstock is melted in an electric arc furnace of Héroult type so as to form a molten liquid bath. This bath is then poured so as to form a stream of liquid which is then dispersed into particles, in the form of beads by blowing with compressed air and isolated by casting.

Several melting/casting cycles are carried out by adjusting, in the composition, the oxides of yttrium, of cerium, of aluminium and optionally of zirconium and of titanium.

This technique makes it possible to have several batches of particles of different compositions, which can be characterized according to methods that are well known to a person skilled in the art.

The very rapid cooling by blowing does not make it possible to crystallize the matrix, except in a marginal manner. A heat treatment is therefore necessary in order to generate crystallites distributed within the matrix.

In order to do this, the particles to be treated are placed by batch in combustion boats which are placed in a heat treatment furnace. The cycle comprises a rise in temperature at a rate of 120° C./h, from ambient temperature up to a first temperature hold (known as “hold 1”) equal to 850° C., for a time between 0 and 10 hours, optionally followed by a second hold (known as “hold 2”) at a temperature of 1000° C. for a time between 1 hour and 10 hours.

The rate of rise in temperature between the end of hold 1 at 850° C. and the beginning of hold 2 at 1000° C. is 120° C./h. After the temperature hold 2, the drop in temperature is carried out at a rate of 200° C./h.

Results

The results obtained are summarized in the table below:
“pvc” specifies the presence (“yes”) or absence (“no”) of a crystallization distributed throughout the entire glassy phase;
“D” specifies the diameter “D” of the largest circle that it is possible to place on a view of a section in the middle of the product, taken using a transmission electron microscope (TEM), without any crystallite being included, even partially, within this circle;
“size of the crystallites” specifies that at least 80% of the crystallites have a size within the range indicated;
“F<0.4” indicates the presence (“yes”) or absence (“no”) of more than 5% by number of crystallites with F<0.4; and
“DC” specifies the degree of coverage of the matrix.

TABLE 1

| | | | | | | | | | | Crystallization | |
|---|---|---|---|---|---|---|---|---|---|---|---|
| | | | | | | | | Other | SiO₂/ | heat treatment | |
| Ex | ZrO₂ % | SiO₂ % | Y₂O₃ % | Al₂O₃ % | TiO₂ % | CeO₂ % | MgO % | oxides % | Al₂O₃ | Hold 1 | Hold 2 |
| 1 (*) | 67 | 31 | 0 | 1 | — | 0 | 0 | 1 | 31 | — | — |
| 2 (*) | 67 | 31 | 0.7 | 1 | — | 0 | 0 | 0.3 | 31 | — | — |
| 3 (*) | 67 | 30.4 | 1.1 | 1.2 | — | 0 | 0 | 0.3 | 25.3 | — | — |
| 4 (*) | 62.9 | 7.4 | 3.5 | 4.8 | 1.7 | 19.2 | 0 | 0.5 | 1.5 | — | — |
| 5 | 62.9 | 7.4 | 3.5 | 4.8 | 1.7 | 19.2 | 0 | 0.5 | 1.5 | 10 h at 850° C. | 10 h at 1000° C. |
| 6 | 62.9 | 7.4 | 3.5 | 4.8 | 1.7 | 19.2 | 0 | 0.5 | 1.5 | — | 1 h at 1000° C. |
| 7 (*) | 64.3 | 7.9 | 3.6 | 9.4 | — | 14.2 | 0 | 0.6 | 0.8 | — | — |
| 8 | 64.3 | 7.9 | 3.6 | 9.4 | — | 14.2 | 0 | 0.6 | 0.8 | 3 h at 850° C. | — |
| 9 | 64.3 | 7.9 | 3.6 | 9.4 | — | 14.2 | 0 | 0.6 | 0.8 | 10 h at 850° C. | — |
| 10 | 64.3 | 7.9 | 3.6 | 9.4 | — | 14.2 | 0 | 0.6 | 0.8 | 3 h at 850° C. | 10 h at 1000° C. |
| 11 | 64.3 | 7.9 | 3.6 | 9.4 | — | 14.2 | 0 | 0.6 | 0.8 | 10 h at 850° C. | 10 h at 1000° C. |
| 12 | 63.5 | 6.2 | 2 | 7.6 | 4.4 | 15.7 | 0 | 0.6 | 0.8 | 10 h at 850° C. | 10 h at 1000° C. |
| 13 | 72.1 | 4.9 | 2.9 | 4 | 1.2 | 14.5 | 0 | 0.4 | 1.2 | 10 h at 850° C. | 10 h at 1000° C. |
| 14 | 65 | 8.2 | 3.5 | 5.5 | 1.8 | 15.4 | 0 | 0.6 | 1.5 | 10 h at 850° C. | 10 h at 1000° C. |
| 15 | 64.5 | 7.6 | 3.6 | 11.2 | 1.9 | 10.8 | 0 | 0.4 | 0.7 | 10 h at 850° C. | 10 h at 1000° C. |
| 16 | 64.2 | 5.3 | 3.6 | 7.5 | 2.1 | 16.7 | 0 | 0.6 | 0.7 | 10 h at 850° C. | 10 h at 1000° C. |
| 17 | 65.9 | 4.5 | 3.6 | 5.8 | 2 | 17.5 | 0 | 0.7 | 0.8 | 10 h at 850° C. | 10 h at 1000° C. |
| 18 | 61.2 | 4.1 | 3.5 | 4.8 | 2 | 23.7 | 0 | 0.7 | 0.9 | 10 h at 850° C. | 10 h at 1000° C. |
| 19 | 55.1 | 4.6 | 3.3 | 5.4 | 2.2 | 28.6 | 0 | 0.8 | 0.9 | 10 h at 850° C. | 10 h at 1000° C. |
| 20 (*) | 53 | 4.2 | 3.6 | 4.6 | 2 | 31.8 | 0 | 0.8 | 0.9 | 10 h at 850° C. | 10 h at 1000° C. |
| 21 (*) | 53.9 | 2.7 | 3.6 | 4.5 | 2 | 32.6 | 0 | 0.7 | 0.6 | 10 h at 850° C. | 10 h at 1000° C. |
| 22 | 62.9 | 7.1 | 4.2 | 5.4 | 1.9 | 17.7 | 0 | 0.8 | 1.3 | 10 h at 850° C. | 10 h at 1000° C. |
| 23 | 64 | 8 | 3.5 | 4.8 | — | 19.2 | 0 | 0.5 | 1.7 | 10 h at 850° C. | 10 h at 1000° C. |
| 24 | 63.1 | 7.7 | 3.6 | 5.1 | 1.1 | 18.8 | 0 | 0.6 | 1.5 | 10 h at 850° C. | 10 h at 1000° C. |

| | | | | | | | | Wear in |
|---|---|---|---|---|---|---|---|---|
| | | | Size of the | | | | | basic |
| | | | crystallites | | | | Planetary | medium |
| Ex | pvc? | D | (nm) | F < 0.4? | DC | Density | wear (%) | (g/h) |
| 1 (*) | no | — | — | — | — | 3.8 | 6 | 2.2 |
| 2 (*) | no | — | — | — | — | 3.8 | 5 | 2.2 |
| 3 (*) | no | — | — | — | — | 3.8 | 4 | 3.5 |
| 4 (*) | no | — | — | — | — | 5.3 | 1.9 | 3.8 |
| 5 | yes | <1 | 10 to 35 | No | 60 | 5.3 | 1.6 | 1.8 |
| 6 | yes | <1 | 30 to 100 | Yes | 70 | 5.3 | 1.7 | 3.3 |
| 7 (*) | no | — | — | — | — | 5.1 | 1.8 | 3.5 |
| 8 | yes | ≈3.5 | 10 to 50 | No | — | 5.1 | 1.6 | — |
| 9 | yes | ≈3.5 | 5 to 35 | No | 15 | 5.1 | 1.6 | 1.7 |
| 10 | yes | ≈2 | 20 to 250 | No | 40 | 5.1 | 1.5 | 1.5 |
| 11 | yes | ≈2 | 15 to 300 | No | 40 | 5.1 | 1.5 | 1.2 |
| 12 | yes | <1 | 10 to 30 | No | — | 5.2 | 1.6 | — |
| 13 | yes | <1 | 10 to 30 | No | — | 5.5 | 1.7 | |
| 14 | yes | — | — | No | — | 5.2 | 1.5 | — |
| 15 | yes | <1 | 50 to 400 | No | 30 | 4.9 | 1.7 | 1.1 |
| 16 | yes | — | — | No | — | 5.3 | 1.7 | — |
| 17 | yes | — | — | No | — | 5.5 | 1.7 | — |
| 18 | yes | — | — | No | — | 5.6 | 2 | — |
| 19 | yes | — | — | Yes | — | 5.6 | 3 | — |
| 20 (*) | yes | <1 | 15 to 50 | Yes | — | 5.6 | 7 | — |
| 21 (*) | yes | <1 | 15 to 50 | Yes | — | 5.7 | 7.2 | — |
| 22 | yes | — | — | No | — | 5.3 | 1.6 | — |
| 23 | yes | <1 | 60 to 200 | Yes | 80 | 5.3 | 1.6 | 2.8 |
| 24 | yes | — | — | No | 55 | 5.3 | 1.6 | 2.2 |

(*): Example outside of the invention

Planetary Wear

The examples according to the invention have a planetary wear resistance greater than that of the examples having the same chemical composition but that are free of crystallites distributed within their matrix, as illustrated by a comparison between Example 4 (non-crystalline matrix) and Examples 5 and 6 (crystalline matrix) or a comparison between Example 7 (non-crystalline matrix) and Examples 8, 9, 10 and 11 (crystalline matrix). Indeed Examples 5 and 6 have an improvement of 16% and 11% respectively relative to Example 4, whereas Examples 8, 9, 10 and 11 have an improvement of 11%, 11%, 17% and 17% relative to Example 7.

A comparison of Examples 5 and 6 also shows the advantage of a heat treatment having two holds with hold times greater than 1 hour.

A comparison of Examples 8 and 9 shows that a duration of hold 1 greater than 3 hours does not necessarily improve the planetary wear resistance. However, a comparison of Examples 10 and 11 shows that a duration of hold 1 greater than 3 hours improves the resistance to wear in a basic medium. These examples also confirm the advantage of a heat treatment having two holds.

Examples 11 to 23 illustrate, under identical heat treatment conditions, the influence of the chemical composition on the planetary wear resistance. They make it possible, in particular, to observe a sudden deterioration in the planetary wear resistance when the CeO₂ content exceeds 31% (Examples 20 and 21).

Examples 5, 22 and 24 are preferred above all in regard of the planetary wear test.

Wear in Basic Medium

A comparison of Examples 4 and 5 with 6, or 7 and 9 with 11 shows the advantage of a heat treatment, and more generally of the presence of crystallites distributed within the matrix, for increasing the resistance to wear in a basic medium.

A comparison of Examples 5 and 6 shows however that it is preferable for the matrix not to comprise elongated crystallites when the product according to the invention is intended to be used in a basic medium.

A comparison of Examples 9 to 11, and especially of Example 9 with Examples 10 and 11 shows that a reduction in the area of the matrix surfaces that do not contain a crystallite is also useful in an application in a basic medium.

An SiO₂/Al₂O₃ ratio<1, or even less than 0.8 is preferred.

A comparison of Examples 10 and 11 lastly shows that a duration of hold 1 greater than 3 hours improves the resistance to planetary wear in a basic medium. These examples also confirm the advantage of a heat treatment having two holds.

In order to optimize the behaviour in a basic medium, in particular for a microgrinding application in a basic medium, Example 5 is considered to be the best product since it combines a density greater than or equal to 5.3, a planetary wear resistance of 1.6 and a resistance to wear in a basic medium of less than or equal to 1.8.

In all the examples according to the invention, the inventors have observed an absence of cracks and pores.

As it now clearly appears, the invention provides a product that has a remarkable planetary wear resistance, and even in certain embodiments a very good resistance to wear in a basic medium.

Of course, the present invention is not limited to the embodiments described, provided by way of illustrative and non-limiting examples.

In particular, the invention is not limited to fused particles, but extends to any type of fused product, especially to thin plates. The field of application of the products according to the invention is not limited to microgrinding, but extends to all applications where the qualities described above would be likely to be useful, and especially to microdispersion in a wet medium and to surface treatment.

1. Process for manufacturing a product, comprising the following successive steps:
a) mixing raw materials to form a starting feedstock;
b) melting the starting feedstock so as to form a molten liquid;
c) solidifying the molten liquid so as to obtain a fused product comprising crystals linked by a glassy phase; and
d) crystallization heat treatment of the glassy phase of said fused product,
in which the composition of the starting feedstock is adapted in order to manufacture a product having the following chemical composition, as weight percentages based on the oxides, and for a total of 100%:
40%≦(ZrO₂+HfO₂)≦94%;
4%≦CeO₂<31%;
0%≦Y₂O₃;
0%≦Al₂O₃;
2%≦SiO₂;
0%≦MgO;
0%≦TiO₂; and
other oxides≦1%.

2. Process according to the claim 1, in which said heat treatment in step d) comprises a nucleation operation at a first temperature above the glass transition temperature T_{g} of the glassy phase of the product resulting from step c) and/or a growth operation at a second temperature above the glass transition temperature T_{g} of the glassy phase of the product resulting from step c), the second temperature being, when the growth operation follows a nucleation operation, at least 50° C. higher than said first temperature.

3. Process according to claim 2, in which the heat treatment in step d) comprises a hold at a temperature between 800° C. and 1100° C.

4. Process according to claim 3, in which the heat treatment in step d) comprises a first hold at a temperature between 820° C. and 880° C. followed by a second hold at a temperature between 970° C. and 1070° C.

5. Process according to claim 3, in which said hold at a temperature between 800° C. and 1100° C. and/or said first hold and/or said second hold lasts at least 1 hour.

6. Process according to claim 5, in which said hold at a temperature between 800° C. and 1100° C. and/or said first hold and/or said second hold lasts at least 5 hours.

7. Process according to claim 1, in which the composition of the starting feedstock is adapted in order to manufacture a product having the following chemical composition, as weight percentages based on the oxides, and for a total of 100%:
45%≦(ZrO₂+HfO₂)≦85%;
6%≦CeO₂<31%;
0.8%≦Y₂O₃≦8.5%;
0%≦Al₂O₃≦30%;
2%≦SiO₂≦37%;
0≦MgO≦6%;
0≦TiO₂≦8.5%; and
other oxides≦1%.

8. Process according to claim 7, in which the composition of the starting feedstock is adapted in order to manufacture a product having the following chemical composition, as weight percentages based on the oxides, and for a total of 100%:
55%≦ZrO₂+HfO₂≦75%;
10%≦CeO₂≦30%;
1.5%≦Y₂O₃≦5%;
0%≦Al₂O₃≦15%;
3%≦SiO₂≦12%;
0%≦MgO≦2%;
0%≦TiO₂≦5%; and
other oxides<1%.

9. Process according to claim 8, in which the composition of the starting feedstock is adapted in order to manufacture a product having the following chemical composition, as weight percentages based on the oxides, and for a total of 100%:
55%≦ZrO₂+HfO₂≦75%;
10%≦CeO₂≦30%;
1.5%≦Y₂O₃≦5%;
4%≦Al₂O₃≦12%;
5%≦SiO₂≦12%;
0%≦MgO≦2%;
1.5%≦TiO₂≦3%; and
other oxides<1%.

10. Process according to claim 1, in which the composition of the starting feedstock is adapted in order to manufacture a product such that, by denoting the CeO₂/(ZrO₂+HfO₂) weight ratio as “C” and the Y₂O₃/(ZrO₂+HfO₂) weight ratio as “Y”:
0≦C≦0.6 and 0.02≦Y≦0.098 and
when Y<0.082, Min(63.095 Y²−11.214 Y+0.4962; 0.25)≦C and
C≦250 Y²−49.1 Y+2.6.

11. Process according to claim 1, in which the composition of the starting feedstock is adapted in order to manufacture a product such that the SiO₂/Al₂O₃ weight ratio is less than or equal to 1.

12. Process according to claim 11, in which the composition of the starting feedstock is adapted in order to manufacture a product such that the SiO₂/Al₂O₃ weight ratio is between 0.3 and 0.75.

13. Process according to claim 1, adapted so that at the end of step c), the product has a shape, at least one dimension of which is less than 30 mm.

14. Process according to claim 13, in which said product obtained at the end of step c) has the shape of a bead having a size of less than or equal to 4 mm.

15. Products obtained or capable of having been obtained by means of a process according to claim 1.

16. A grinding agent, an agent for dispersion in a wet medium, a surface treatment agent, a supporting agent or a heat-exchange agent comprising a product according to claim 15.

17. An agent for grinding suspensions having a pH>8 and comprising a product according to claim 15.
